(19) United States
(12) Patent Application Publication
(10) Pub. No.: US 2012/0319406 A1
(43) Pub. Date: Dec. 20, 2012

(54) Method for Operating a Wave Energy Converter and Wave Energy Converter

(75) Inventors: Norbert Hoffmann, Winsen (DE); Jasper Behrendt, Hamburg (DE); Nicolas Houis, Bietigheim-Bissingen (DE); Nik Scharmann, Bietigheim-Bissingen (DE); Bejamin Hagemann, Gerlingen (DE); Markus Perschall, Aschaffenburg (DE); Alexander Poddey, Vaihingen/Enz (DE); Daniel Thull, Stuttgart (DE); Michael Hilsch, Stuttgart (DE)

(73) Assignee: Robert Bosch GmbH, Stuttgart (DE)

(21) Appl. No.: 13/523,785

(22) Filed: Jun. 14, 2012

(30) Foreign Application Priority Data
Jun. 17, 2011 (DE) 10 2011 105 169.8

(51) Int. Cl. F03B 15/00; F03B 13/16

(52) U.S. Cl. 290/53; 415/1; 415/13

(57) ABSTRACT

A method for operating a wave energy converter for converting energy from a wave movement of a fluid into a different form of energy. The wave energy converter including at least one rotor and at least one energy converter coupled to the at least one rotor. A first torque acting on the at least one rotor is generated by the movement of the waves and a second torque acting on the at least one rotor is generated by the at least one energy converter. A desired effective force acting perpendicular to an axis of rotation of the at least one rotor is set by setting the first and/or second torque.

This application claims priority under 35 U.S.C. §119 to patent application no. DE 10 2011 105 169.8, filed on Jun. 17, 2011 in Germany, the disclosure of which is incorporated herein by reference in its entirety.

The present disclosure relates to a method for operating a wave energy converter for converting energy from the wave movement of a fluid into a different form of energy, and a correspondingly operated wave energy converter.

### BACKGROUND

Different devices from the prior art, which can be used offshore or near the shoreline, are known for converting energy from the movement of waves in bodies of water into usable energy. A summary of wave energy power plants is given, for example, in G Boyle's “Renewable Energy” (2^{nd} ed), Oxford University Press, Oxford 2004.

There are differences, inter alia, in the way in which the energy is taken from the movement of the waves. Thus, buoys or floats floating on the surface of the water are known which drive, for example, a linear generator as they rise and fall. In another design of machine, the so-called “wave roller”, a flat resistant element which is pivoted back and forth by the movement of the waves is attached to the sea floor. The kinetic energy of the resistant element is converted in a generator into, for example, electrical energy. In such oscillating systems, however, a maximum damping or load factor of only 0.5 can be achieved, so that their profitability is usually not satisfactory.

Within the scope of the present disclosure, advantageous wave energy converters are in particular those which are arranged substantially below the surface of the water and in which a crankshaft or rotor shaft is set in rotation by the movement of the waves.

A system design is known in this connection from the publication by Pinkster et al., “A rotating wing for the generation of energy from waves”, 22^{nd} International Workshop on Water Waves and Floating Bodies (IWWWFB), Plitvice, 2007, in which the lift of a lift runner onto which water flows, i.e. a coupling body generating hydrodynamic lift, is converted into rotational movement.

Moreover, US 2010/0150716 A1 discloses a system consisting of multiple high-speed rotors with lift runners, in which the rotor period is smaller than the wave period and a separate profile adjustment is made. By means of a suitable adjustment of the lift runners (which is, however, not disclosed in detail), resulting forces are generated on the system which can be used for different purposes. A disadvantage of the system disclosed in US 2010/0150716 A1 is the use of high-speed rotors of the Voith-Scheider type which entail a high degree of complexity when adjusting the lift runners. These must be continuously adjusted within a not inconsiderable angular range so as to adapt to the prevailing conditions for the flow onto each lift runner. In addition, an ever increasing number of rotors at defined distances from one another are required in order to compensate the forces resulting from the rotor and generator torque and acting on the individual rotors.

The object of the disclosure is accordingly to improve rotating wave energy converters, in particular with the aim of a greater energy yield and less complexity in terms of structure and/or control technology.

### SUMMARY

Against this background, the present disclosure proposes a method for operating a wave energy converter and a correspondingly operatable wave energy converter. Preferred embodiments are the subject of the following description.

A method proposed according to the disclosure is used to operate a wave energy converter with at least one rotor and at least one energy converter coupled to the at least one rotor, wherein a first torque acting on the at least one rotor is generated by the movement of the waves and a second torque acting on the at least one rotor is generated by the at least one energy converter. It is self-evident that, when a double-sided rotor is used, the “first” torque consists of the two “first” torques which act on each side of the rotor. According to the disclosure, a desired effective force acting perpendicular to an axis of rotation of the at least one rotor is set by setting the first and/or second torque. As explained in detail below, inter alia, a corresponding wave energy converter can thus be operated with just one rotor as the latter can compensate on its own any torques acting on it perpendicular to the axis of rotation or any superimposed forces, and therefore there is no need for any counteracting force of a second or further rotor.

The disclosure proposed here very generally concerns systems using a rotary operating principle, for example converters with multiple rotors as shown, for example in FIG. 15. The following specifications therefore in principle apply for wave energy converters with one or more rotors.

Overall, a wave energy converter is provided with at least one rotor for converting energy from a body of water with a lot of waves, which as explained below advantageously rotates synchronously or largely synchronously with the (orbital) movement or current of the waves, which is advantageous in energy and control technology terms and in which resulting forces can be influenced in a targeted fashion by a corresponding operation and a corresponding structural design and can be used to influence the whole system. With a suitable design and operation, almost complete dissipation and hence exploitation of the arriving wave can be achieved with such a wave energy converter. This is particularly true for monochromatic waves. The lift runners, and therefore coupling bodies, used in a corresponding wave energy converter and which are configured to convert the movement of the waves into a lift force and hence into a torque of a rotor, because of the synchronous or largely synchronous operation, must not be adjusted at all or adjusted only within a narrow range as the flow onto a corresponding profile hereby occurs over the entire rotation of the rotor carrying the profile largely in the same direction of flow. There is therefore no need to adapt the angle of attack γ, as in the known Voith-Schneider rotors (also called pitches), but it can be advantageous.

In waves at sea, the water particles move on largely circular so-called orbital paths (in the form of an orbital movement or orbital current, both terms being used synonymously). The water particles thus move upwards and downwards, below the wave crest in the direction in which the wave propagates, below the trough of the wave counter to the direction in which the wave propagates, and in both zero crossings. The direction of the current at a fixed point below the surface of the water (referred to as local or temporary flow below) thus changes continuously with a specific angular velocity O. In deep water, the orbital current is largely circular and in shallow water the circular orbitals become increasingly shallow ellipses. A flow can be superimposed on the orbital current.

The orbital radii are dependent on the depth to which the wave energy converter is submerged. They are at their greatest at the surface of the water—here the orbital diameter corresponds to the wave height—and increase exponentially as the depth of the water increases. When the depth of the water is approximately half the wave length, therefore only about 5% of the energy can be obtained compared with close to the surface of the water. For this reason, submerged wave energy converters are preferably operated close to the surface.

A rotor is advantageously provided with a largely horizontal rotor axis and at least one coupling body. The rotor advantageously rotates synchronously with the orbital current at an angular velocity ω and is driven by the orbital current via the at least one coupling body. In other words, a torque (referred to in the scope of this disclosure as a “first torque” or “rotor torque”) is generated by the movement of the waves of water, and to be precise by the orbital current of the water, and acts on the rotor. If the period durations of the rotational movement of the rotor and the oribital current coincide at least to a certain extent (cf. below for the term “synchronicity” which is used here), a constant local flow onto the coupling body always results, leaving aside the depth effect that was mentioned and the width effects in the case of large rotor diameters. Consequently, energy can be continuously extracted from the movement of the waves and converted into a usable torque by the rotor.

In this connection, the term “coupling body” is understood to be any structure by means of which the energy of a fluid that flows onto it can be coupled into a movement of a rotor or a corresponding rotor torque. As explained below, coupling bodies can be designed in particular as lift runners (also referred to as blades) but also include drag-type runners.

The term “synchronicity” can here refer to a rotational movement of a rotor, by means of which at any moment a complete coincidence results between the position of the rotor and the direction of the local flow which is caused by the orbital current. A “synchronous” rotational movement of the rotor can, however, also advantageously result from a defined angle or a defined angular range being formed between the position of the rotor, or at least one of the coupling bodies arranged on the rotor, and the local flow (i.e. the phase angle is maintained within the angular range over one revolution). A defined phase shift or phase angle Δ between the rotational movement of the rotor ω and the orbital current O therefore results. The “position” of the rotor or the at least one coupling body arranged on the rotor can thus always be defined, for example, by an imaginary line through the axis of the rotor and, for example, the axis of rotation or center of gravity of a coupling body.

Such a synchronicity can be derived directly, in particular for monochromatic wave states, i.e. wave states with an always constant oribital current O. In real-life conditions, i.e. when actually in heavy seas, in which the orbital velocity and diameter change owing to the mutual superposition of waves, the changing effect of the wind and the like (so-called polychromatic wave states), it can, however, also be provided that the machine is operated at an angle to the respective existing flow which is constant only within a certain range. An angular range can hereby be defined within which the synchronicity is viewed to still be maintained. This can be achieved by suitable control technology measures including the adjustment of at least one coupling body to generate the mentioned first torque and/or a second torque of the energy converter which has a braking or accelerating effect. Not all the coupling bodies must necessarily be adjusted here or be capable of a corresponding adjustment. In particular, there is no need to synchronously adjust multiple coupling bodies.

Alternatively, however, it can also be provided that complete synchronicity in which the flow onto the at least one coupling body takes place locally always from the same direction, can be dispensed with. Instead, the rotor can be synchronized to at least one principal component of the wave (for example, a principal mode of oscillation of superimposed waves) and thus at times lead or trail the local flow. This can be achieved by a corresponding adaptation of the first and/or second torque. Such a form of operation is also covered by the term “synchronous”, as is a fluctuation of the phase angle within certain ranges, which means that the rotor can intermittently experience an acceleration (positive or negative) relative to the phase of the waves.

The speed of a “synchronous” or “largely synchronous” rotor therefore coincides approximately, i.e. within certain limits, with the respective prevailing wave speed. Deviations hereby do not accumulate but largely cancel one another out or are compensated over time or a certain time window. An essential aspect of a control method for a corresponding converter can consist in maintaining the explained synchronicity.

Coupling bodies from the category of lift runners are particularly preferably used which, in the case of a flow at an angle of flow a, in particular generates a lift force directed essentially perpendicular to the flow in addition to a drag force in the direction of the local flow. They can, for example, be lift runners with profiles in accordance with the NACA (National Advisory Committee for Aeronautics) standard but the disclosure is not limited to such profiles. Eppler profiles can be used particularly preferably. In a corresponding rotor, the local flow and the flow angle a linked thereto thus result from a superposition of the orbital current v_{wave} in the above-explained local or temporary direction of wave flow, the rotational speed of the lift runner vᵣₒₜₒᵣ at the rotor and the angle of attack γ of the lift runner. The alignment of the lift runner to the locally existing flow conditions can thus be optimized in particular by adjusting the angle of attack γ of the at least one lift runner. Moreover, the use of flaps similar to those on airplane wings and/or a change in the lift profile geometry (so-called “morphing”) to affect the flow are also possible. The said changes are covered by the formulation “change in form”.

The mentioned first torque can therefore be influenced, for example, by the angle of attack γ. It is known that, as the angle of flow a increases, the resulting forces on the lift runner grow until, at the so-called stall point at which a stall occurs, a drop in the lift coefficient is observed. The resulting forces also increase as the velocity of the current grows. This means that the resulting forces and thus the torque acting on the rotor can be influenced by changing the angle of attack γ and the linked flow angle a.

A second torque acting on the rotor can be provided by an energy converter coupled to the rotor or its rotor base. This second torque, referred to below as the “generator torque”, also acts on the rotational speed vᵣₒₜₒᵣ and thus also influences the flow angle a. In the conventional operation of energy-generating plants, the second torque represents a braking torque which is caused by the interaction of a generator rotor with the associated stator and is converted into electrical energy. A corresponding energy convertor in the form of a generator can, however, also be motorized, at least during certain periods of time, so that the second torque can also act on the rotor in the form of an acceleration torque. In order to achieve the advantageous synchronicity, the generator torque can be set to suit the existing lift profile setting and the forces/torques that result therefrom in such a way that the desired rotational speed is set with the correct phase shift for the orbital current. The generator torque can, inter alia, be influenced by influencing an exciting current through the rotor (in the case of externally excited machines) and/or by initiating the commutation of a power converter connected downstream from the stator.

Lastly, a rotor force which acts on the housing of the rotor as a bearing force directed perpendicular to the rotor axis (also referred to as a reaction force) results from the vectorial superposition of the forces on the individual coupling bodies. This rotor force continually changes its direction as the flow onto the rotor and the position of the coupling bodies also continuously change. In the event of a deliberate or undeliberate asymmetry of the bearing force over time, an effective force results which also acts perpendicular to the rotor axis and, in the form of a translational force or a combination of translational forces in the case of multiple rotors, can influence a position of a corresponding wave energy converter and can be used in a targeted fashion to influence the position. When the coupling bodies are designed accordingly, for example when their longitudinal axes are arranged obliquely, a bearing force directed perpendicular to the rotor axis can be generated too, as explained in detail elsewhere.

Because the rotor is preferably designed as a system that floats below the surface of a body of water with a lot of waves, the explained rotor force acts as a displacing force on the whole rotor and must accordingly be supported when the position of the rotor is not meant to change. As mentioned, this is obtained, for example, in US 2010/0150716 A1 by the provision of multiple rotors with forces that counteract one another. The displacements are thus compensated over one revolution, assuming constant flow conditions onto the coupling bodies and identical settings of the angles of attack γ and hence of the first torque, and a constant second torque.

By virtue of a suitable modification of the rotor force by influencing the first and/or second torque, whilst maintaining synchronicity, it is thus also possible to ensure that the rotor forces per revolution are not compensated, so that a displacement of the rotor perpendicular to its axis of rotation can be obtained.

If a rotor has multiple coupling bodies, it may be provided that each coupling body has its own adjustment device so that the coupling bodies can be set independently of one another. The coupling bodies are advantageously set to the respective locally existing current conditions. Depth and width effects can thereby also be compensated. In the above-explained “synchronous” operation, the generator torque is thus matched to the rotor torque generated by the sum of the coupling bodies.

The rotor can have coupling bodies mounted on both sides, wherein an adjustment system for the at least one coupling body can be provided on one side or both sides. A design with one-sided mounting of the at least one coupling body and with one free end can alternatively be provided.

A rotor can also advantageously be used which has a two-sided rotor base relative to its plane of rotation, at least one coupling body being attached to each side of the rotor base. As a result, the forces which act on a generator coupled to the rotor and can be converted into usable energy can in particular be increased and, by virtue of a targeted influencing of effective torques on both sides of the two-sided rotor base as already explained in part, the position of a corresponding wave energy converter can be controlled in a targeted fashion. If the forces acting on both sides of the two-sided rotor base differ, a torque acting perpendicular to the axis of rotation of the two-sided rotor can be generated on the rotor and the wave energy converter can thus be caused to turn. Precise alignment, for example with respect to the direction in which the waves propagate, is thus possible. Not all coupling bodies necessarily need to be designed to be adjustable hereby, it being sufficient for only some of the coupling bodies to be adjustable. In certain cases it is also possible to dispense with adjustable coupling bodies altogether so that the forces which act in each case can, as explained below, be influenced in a targeted fashion only by a generator torque. This results in a particularly robust structure and reduced maintenance needs, in particular in view of the rough conditions in the open sea.

A housing on which the rotor is rotatably mounted is advantageously provided to mount the rotor. The second torque is preferably effected by an energy converter such as a generator. The generator may thus in particular be a direct-driven generator as drive train losses are hereby minimized. A gearbox can, however, alternatively also be interposed. It is also possible to generate a pressure in a suitable medium with the aid of a pump. This pressure already represents a usable form of energy but it can be converted (again) into a torque, for example with the aid of a hydraulic motor, and fed into a generator.

The coupling bodies can be connected to the rotor of the direct-driven generator directly or indirectly via corresponding lever arms. The coupling bodies are thus advantageously attached at a distance from the axis of rotation. The lever arms can thus be designed as struts or appropriately designed spacing means which connect the coupling bodies to the rotor, but a lever arm can also take the form of an appropriate plate-like structure and only fulfil the physical function of a lever. Depending on the embodiment, flow-technology or structural advantages result hereby.

The adjustment system for adjusting the at least one coupling body can, as mentioned, be a system for changing the angle of attack γ. Alternatively, it is also possible to adjust flaps on the at least one coupling body in a similar way to airplane wings or to change the coupling body geometry (morphing). The adjustment can be performed electromotively—preferably using stepping motors—and/or hydraulically and/or pneumatically.

As an alternative to or in addition to individually adjusting each coupling body, a coupled adjustment of the different coupling bodies can be provided, where the coupling bodies are connected to a central adjustment device, for example via appropriate adjusting levers. This limits the flexibility of the machine only slightly but can simplify the overall structure.

In the case of the geometry of the lift runners which are preferably used, simple extruded/prismatic structures can be used in which the coupling body cross section does not change over the length of the coupling bodies. However, it is also provided according to the disclosure, in particular for the case of one-sided mounting, to use 3D coupling body geometry with tapering coupling body ends and/or a sweep, as is also used in airplane manufacture. These have a positive effect on the coupling body stability/elastic line. Furthermore, a coupling body which tapers toward the coupling body tip results in reduced tip vortices which can lead to losses of efficiency. In addition, winglets on one and/or both coupling body ends can here also be used.

It may be provided that the length and angular position of the lever arm of the at least one lift runner can be set in order to be able to adapt the machine to different wave states, for example different orbital radii.

Rotors can be used in which the coupling bodies are aligned with their longitudinal axes largely parallel to the rotor axis. The coupling bodies can, however, also be arranged at an angle to the rotor, their longitudinal axes extending at least temporarily obliquely to the axis of rotation. The longitudinal axes can converge or diverge or be arranged offset laterally with respect to one another. The angular arrangement can thus relate to both the radial and the tangential alignment.

An angular arrangement of the at least one coupling body relating to the radial alignment thus has a stabilizing effect to a certain degree on the performance of the system. A different optimal coupling body radius thus results for different wave states. As described above, this can be designed so that it can be set. A radial/angular arrangement of the coupling bodies hereby in particular means that the machine can be operated at close to optimum over a wide range of wave states. The whole system thus behaves in an, as it were, more tolerant fashion and permits operation over a wide range of wave states, for example with different orbital radii. The angular arrangement can also be designed so that it can be set. In some circumstances, such adjustability of the coupling body angle can be effected more simply than changing the length of a lever arm.

An appropriate angular arrangement, in particular in the form of diverging or converging coupling bodies, can also be used in order to generate an axial force on a relevant rotor which can be used to compensate other forces or to change position, in addition to an above-mentioned effective force perpendicular to the rotor axis which is explained in more detail below.

A control device is provided to control the wave energy converter or the rotor and the forces which are exerted. This control device uses the adjustable second torque of the at least one rotor and/or the adjustable first torque as control values, for example by adjusting the at least one coupling body, in other words the first torque. The currently existing local current field of the wave can be used in addition to the values for the state of the machine with the detection of the rotor angle and/or coupling body adjustment. This current field can be determined using appropriate sensors. These sensors can thus be arranged in co-rotating fashion on parts of the rotor and/or on the housing and/or independently of the machine, preferably upstream or downstream from it. A local, regional and global detection of a current field, the direction in which the waves propagate, an orbital current and the like can be provided, wherein a “local” detection can relate to the conditions prevailing directly on a component of a wave energy converter, a “regional” detection can relate to groups of components or an individual unit, and a “global” detection can relate to the whole system or a corresponding wave farm. It is consequently possible to undertake predictive measurement and forecasting of wave states. Measured values can, for example, be the current velocity and/or current direction and/or wave height and/or wavelength and/or period duration and/or wave propagation speed and/or machine movement and/or holding torque of the coupling body adjustment and/or adjusting torques of the coupling bodies and/or the rotor torque and/or forces introduced into a mooring.

The currently existing conditions of the flow onto the coupling body can preferably be determined from the measured values, so that the coupling body and/or the second torque can be set appropriately in order to achieve the higher-order control aims.

It is, however, particularly preferably provided that the entire propagating current field is known from suitable measurements upstream from the machine or an array of many machines. The subsequent local flow onto the machine can thus be determined from suitable calculations, which makes it possible to control the system particularly precisely. Using such measurements, it is in particular possible to implement a higher-level control of the machine which is aligned, for example, with a principal component of the arriving wave. A particularly robust operation of the machine is thus possible.

Further advantages and embodiments of the disclosure are apparent from the description and the attached drawings.

It goes without saying that the abovementioned features and those which will be explained below can be used not only in the respectively described combination, but also in other combinations, or on their own, without going beyond the scope of the present disclosure.

The disclosure is shown schematically in the drawings with the aid of exemplary embodiments and is described in detail below with reference to the drawings.

### BRIEF DESCRIPTION OF THE DRAWINGS

FIG. 1 shows a wave energy converter with a rotor with two lift runners in a side view and illustrates the angle of attack γ and the phase angle Δ between the rotor and the orbital current.

FIG. 2 shows the resulting flow angles a₁ and a₂ and the resulting forces on the coupling bodies of the rotor from FIG. 1.

FIG. 3 illustrates a method for influencing an effective force with the aid of graphs for phase angle, angle of attack, torque and force.

FIG. 4 shows a side view of a wave energy converter with a rotor with a greater radial extent with a different flow onto the coupling bodies and the resulting forces.

FIG. 5 shows two rotors for converting energy from the movement of waves with disk-like rotor bases in a perspective view.

FIG. 6 shows a wave energy converter with a rotor for converting energy from the movement of waves with lever arms for attaching coupling bodies in a perspective view.

FIG. 7 shows a wave energy converter with a rotor for converting energy from the movement of waves with a rotor base designed as a generator runner in a perspective view.

FIG. 8 shows rotors for converting energy from the movement of waves with oblique coupling bodies in a perspective view.

FIG. 9 shows a further wave energy converter for converting energy from the movement of waves with oblique coupling bodies in a side view and a plan view.

FIG. 10 shows a wave energy converter with a rotor for converting energy from the movement of waves with a double-sided coupling body arrangement in a perspective view.

FIG. 11 shows a further wave energy converter with a rotor for converting energy from the movement of waves with a double-sided coupling body arrangement in a perspective view.

FIG. 12 shows a further wave energy converter with a rotor for converting energy from the movement of waves with a double-sided coupling body arrangement in a perspective view.

FIG. 13 shows a wave energy converter with a rotor for converting energy from the movement of waves with a double-sided coupling body arrangement on a mounting structure in a perspective view.

FIG. 14 shows a wave energy converter with a rotor for converting energy from the movement of waves on a mounting structure and with an anchoring apparatus in a side view.

FIG. 15 shows multiple wave energy converters with rotors for converting energy from the movement of waves on a mounting structure in a perspective view.

FIG. 16 shows multiple wave energy converters with rotors for converting energy from the movement of waves on a mounting structure with a double-sided coupling body arrangement in a perspective view.

FIG. 17 shows multiple wave energy converters with rotors for converting energy from the movement of waves on a mounting structure with a partial double-sided coupling body arrangement in a perspective view.

FIG. 18 illustrates the arrangement of sensors on and around a wave energy converter with a rotor for converting energy from the movement of waves on a mounting structure in a side view.

FIG. 19 illustrates possible shape modifications on coupling bodies in a perspective view.

### DETAILED DESCRIPTION

Identical elements or those which perform the same function have been given the same reference symbols in the drawings. For the sake of clarity, explanations are not repeated.

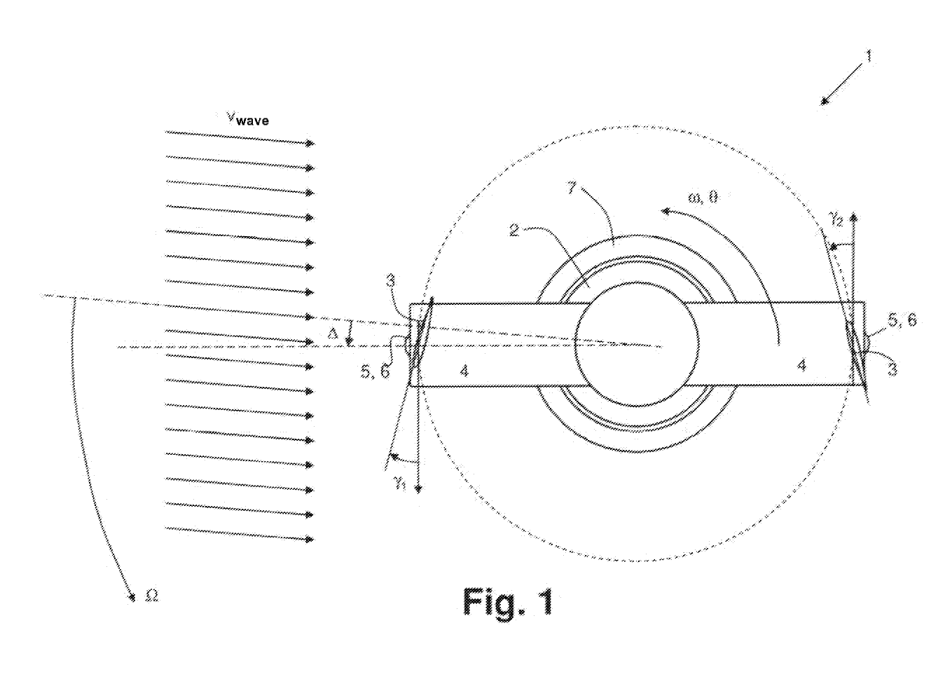

A wave energy converter 1 with a rotor 2, 3, 4 with a rotor base 2, a housing 7 and two coupling bodies 3 which are each fastened in nonrotatable fashion to the rotor base 2 via lever arms 4 is shown in FIG. 1. The rotor 2, 3, 4 is intended to be arranged beneath the surface of a body of water with a lot of waves, for example an ocean. Its axis of rotation is intended to be oriented largely horizontally and largely perpendicular to the current direction in which the waves of the body of water is propagating. In the example shown, the coupling bodies 3 take the form of lift profiles. Deep water conditions exist hereby, in which the orbital paths of the water molecules extend, as explained, in a largely circular fashion. The rotating components of the wave energy converter are thus preferably provided with a largely neutral lift in order to prevent a preferred position.

The coupling bodies 3 are designed as lift runners and arranged at an angle of 180° relative to one another. The lift runners are preferably mounted in the region of their center of pressure in order to reduce rotational torque occurring on the lift runners during operation and hence the requirements for the mounting and/or the adjustment devices.

The radial spacing between the suspension point of a coupling body and the rotor axis is 1 m to 50 m, preferably 2 m to 40 m, particularly preferably 4 m to 30 m, and most particularly preferably 5 m to 20 m.

Also shown are two adjustment devices 5 for adjusting the angles of attack γ₁ and γ₂ of the coupling bodies 3 between the blade chord and tangent. The two angles of attack γ₁ and γ₂ are preferably oriented in opposite directions and preferably have values of −20° to 20°. However, larger angles of attack can also be provided, in particular when the machine is starting up. The angles of attack γ₁ and γ₂ can preferably be adjusted independently of each other. The adjustment devices can, for example, be electromotive adjustment devices—preferably with stepping motors—and/or hydraulic and/or pneumatic components.

The two adjustment devices 5 can additionally each have a sensor system 6 for determining the existing angles of attack γ₁ and γ₂. A further sensor system (not shown) can determine the state of rotation of the rotor base 2.

The orbital current flows onto the wave energy converter 1 at a flow velocity v_{wave}. The flow is the orbital current of sea waves with a direction that is constantly changing. In the case shown, the orbital current turns counterclockwise and the associated wave thus propagates from right to left. In the case of monochromatic waves, the flow direction thus changes with the angular velocity O=2 p f=const., where f represents the frequency of the monochromatic wave. In contrast, in polychromatic waves O is subject to a time change, O=f(t), as the frequency f is a function of time, f=f(t). It is provided that the rotor 2, 3, 4 rotates synchronously with the orbital current of the movement of the waves at an angular velocity ω, the term synchronicity being understood in the above-explained fashion. Hereby, O~ is for example ω. A value or a range of values for an angular velocity ω of the rotor is thus predefined on the basis of an angular velocity O of the orbital current or is adapted to the latter. Constant control or a temporary or short-term adaptation can result hereby.

As explained in detail below, a first torque acting on the rotor 2, 3, 4 is generated by the action of the flow onto the coupling bodies at the flow velocity v_{wave}. It is moreover provided that a preferably modifiable second torque in the form of drag, in other words a braking torque or an accelerating torque, can be applied to the rotor 2, 3, 4. Means for generating the second torque are arranged between the rotor base 2 and the housing 7. It is thus preferably provided that the housing 7 is the stator of a direct-driven generator and the rotor base 2 is the runner of this direct-driven generator, the mounting, windings, etc of which are not shown. However, as an alternative, other drive train variants can also be provided in which the means for generating the second torque also comprise a further gearbox and/or hydraulic components such as, for example, pumps in addition to a generator. The means for generating the second torque can additionally or also only comprise a suitable brake.

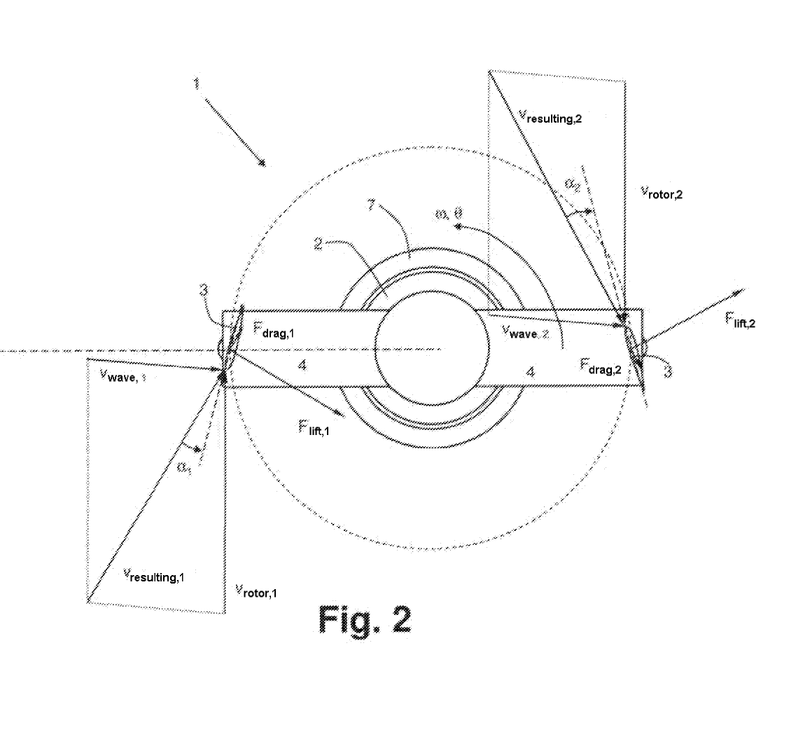

A phase angle Δ, the magnitude of which can be influenced by setting the first and/or the second torque, exists between the orientation of the rotor, illustrated by a lower dashed line which runs through the axis of the rotor and the center of the two adjustment devices 5, and the direction of the orbital current, illustrated by the upper dashed line which runs through one of the velocity arrows v_{wave}. A phase angle of −45° to 45°, preferably −25° to 25°, and particularly preferably −15° to 15° here proves to be particularly advantageous for generating the first torque, because here the orbital current v_{wave} and the flow due to the natural rotation of the rotor vᵣₒₜₒᵣ (see FIG. 2) are oriented largely perpendicularly to each other, which maximizes the rotor torque. With the required synchronicity being preserved, Δ⁻ is const., fluctuation about a mean value of Δ also being understood as synchronous within the scope of the disclosure, as already explained above. The coupling bodies are represented in FIG. 1 and in the other figures only be way of example in order to define the different machine parameters. During operation, the angles of attack of the two coupling bodies are preferably designed to be the opposite way round to that shown. The coupling body on the left in FIG. 1 would then be shifted inwards and the coupling body on the right in FIG. 1 shifted outwards.

The resulting flow conditions and the forces which occur on the coupling bodies and result in a rotor torque are shown in FIG. 2. For the sake of simplification, it is here assumed that the flow is uniform over the whole rotor cross section and has the same magnitude and the same direction. However, it may occur, in particular for rotors with large radial extents, that the different coupling bodies 3 of the rotor 2, 3, 4 are located at different positions relative to the wave, whish results in a locally different flow direction. This can, however, be compensated, for example by individually setting the respective angle of attack γ.

In FIG. 2, the local flows onto both coupling bodies are represented by the orbital current (v_{wave,1}) and by the natural rotation (v_{rotor,1}), the flow velocity (v_{resulting,1}) resulting from these two flows, and the resulting flow angles a₁ and a₂. Moreover, the resulting lift and drag forces F_{lift,1} and F_{drag,1} on both coupling bodies are also derived, which are dependent on both the magnitude of the flow velocity and the flow angles a₁ and a₂ and hence also on the angles of attack γ₁ and γ₂ and are oriented perpendicular or parallel to the direction of v_{resulting,1}.

For the case shown, a counterclockwise rotor torque results from the two lift forces F_{lift,1} and a rotor torque of smaller magnitude in the opposite direction (i.e. clockwise) results from the two drag forces F_{drag,1}. The sum of the two rotor torques results in a rotation of the rotor 1, the velocity of which can be set by the countertorque by the adjustable second torque.

If the synchronicity required within the scope of the disclosure is achieved with A~ const., it can be seen immediately from FIG. 2 that the flow conditions of the two coupling bodies 3 do not change over the rotation of the rotor for monochromatic cases in which the magnitude of the flow v_{wave,1} and the angular velocity O remain constant. This means that, with constant angles of attack γ, a constant rotor torque is generated which can be tapped with a constant second torque of a corresponding generator.

As well as a rotor torque, the forces affecting the coupling bodies also yield a resulting rotor force by the vectorial addition of F_{lift,1}, F_{drag,1}, F_{lift,2} and F_{drag,2}. The latter acts as a bearing force on the housing and must accordingly be supported when a displacement of the housing is undesired. Whilst, assuming identical flow conditions (v_{wave,1}, Δ, O, ω, a₁, a₂, γ₁, γ₂=const.), the rotor torque remains constant, this applies for the resulting rotor force only in magnitude. Owing to the constantly changing direction of the orbital current and the synchronous rotation of the rotor, the direction of the rotor force also changes accordingly.

As well as influencing the rotor torque by adjusting the angles of attack γ and/or adjusting the phase angle Δ, the magnitude of this rotor force can also be influenced by changing the angles of attack γ (as a result of which the flow angles a change), by changing the rotor angular velocity ω and/or the phase angle Δ—for example by changing the generator torque applied as a second torque (as a result of which vᵣₒₜₒᵣ changes) and/or by a combination of these changes. The synchronicity described in the introduction is here preferably preserved.

By suitably adjusting these control values per revolution and changing the associated rotor force, the wave energy converter can be moved in any desired radial direction. It should be noted hereby that the view in FIG. 2 comprises only an orbital current which is directed perpendicular to the axis of rotation and has no flow components in the direction of the plane of the drawing. In contrast, if the flow onto the rotor is oblique, as is the case in real-life conditions, a rotor force results which has an axial force component as well as a force component directed perpendicular to the rotor axis. This is due to the fact that the hydrodynamic drag force of a coupling body is directed in the direction of the local flow.

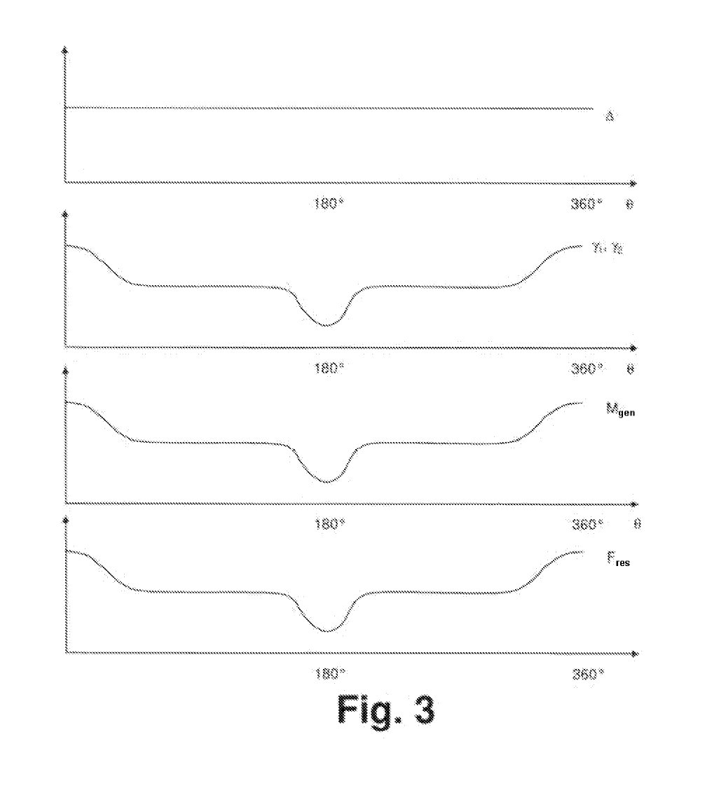

A possible procedure for influencing the rotor force during one revolution is shown qualitatively in FIG. 3. It is assumed here that, when strict synchronicity (Δ=const.) is preserved, and simplifying initially for monochromatic wave states too, a displacement of the wave energy converter 1 from FIG. 1 horizontally to the right is to be achieved, that the flow onto the rotor is from the left for θ=0 and that the resulting rotor force is directed approximately in the direction of flow. For different directions of the rotor force, the procedure described below can be adapted as appropriate.

A phase angle Δ, a first and a second angle of attack γ₁ and γ₂, a second torque (here represented as a generator torque M_{gen}), and an effective force Fᵣₑₛ over a phase angle θ are shown respectively in the individual graphs in FIG. 3.

In this respect, the resulting forces on the coupling bodies are, for example, maximized by large angles of attack γ, for example in the range c. 320°<θ<40°, which results in a large resulting force on the rotor in the direction of flow (to the right). In order to achieve strict synchronicity, the second torque in the form of the generator torque is also increased in a suitable fashion as large rotor torques, which would otherwise lead to an acceleration of the rotor and hence a change in the phase angle Δ, also result from the large flow angles a. For the range c. 140°<θ<220°, in which the flow is from the right and the rotor force is thus largely directed to the left, these values are reduced accordingly so that the force directed to the left is accordingly lower. For the intermediate ranges with flows from below and above, both values are set to a mean value so that the forces directed upwards and downwards here largely cancel each other out over one revolution. Overall, the wave energy converter 1 is thus shifted horizontally to the right by a corresponding distance per revolution.

To sum up, it can be established that the rotor force is advantageously influenced when it is oriented in or counter to the direction in which, for example, a displacement is to be achieved. The two angles of attack γ can thus also be modified independently of each other in a suitable fashion, in particular to take account of locally different flow ratios (v_{wave} can in particular differ in the case of large rotor extents or in the case of polychromatic flow conditions), the generator torque then being matched in a suitable fashion to the rotor torque which results in each case in order to achieve absolute synchronicity. This can affect the line of action of the rotor force and thus the oscillating behavior of the rotor 1.

A similar effect would result if one of the two changes were not made in FIG. 3. A corresponding overall displacement of the system would occur then too but at a reduced speed.

Similarly, the wave energy converter machine can also be displaced vertically or in any spatial direction perpendicular to the rotor axis. Such a method can also be used to compensate forces superimposed on the orbital current, for example from marine currents, and prevent the machine from drifting away. This also reduces in particular the need for anchoring. It can also be provided to use the generation of directed resulting forces to stabilize the whole system and/or to compensate forces.

There is a similar method for the case of polychromatic waves, except that here the changes do not need to be made periodically as the direction of flow does not change periodically. The existing flow direction, particularly preferably incidentally the local flow v_{wave} onto the individual coupling bodies 3, can however be detected by a suitable sensor system, so that a corresponding control of the machine for generating directed resulting forces is possible.

If the requirement to preserve absolute synchronicity is dispensed with and the phase angle Δ is thus allowed to fluctuate about a mean value, a displacement of the rotor by cyclically influencing the resulting rotor force can also be achieved by suitable adjustment of just either the first or the second torque.

If, for example, with a constant second torque, at least one of the two angles of attack γ is increased, higher forces F_{lift} and F_{drag} result on at least one of the two coupling bodies 3 and, linked thereto, the resulting rotor force, and a larger rotor torque. Because the second torque is held constant, this results in an acceleration of the rotor and thus a change in the phase angle Δ. Reducing the angle of attack γ results in reduced forces and, when the second torque is constant, a deceleration and hence a change in the phase angle Δ in the opposite direction.

It is provided that the phase angle Δ can fluctuate about a mean value Δ=0°. In order to fulfil this wider notion of synchronicity, it is here provided that the phase angle Δ can be varied within a bandwidth between −90°<Δ<90°.

Should a case occur, because of special operating circumstances, where the phase angle Δ infringes this specification, the signs of the angles of attack γ of these coupling bodies can be swapped so that the abovementioned phase angle is achieved again for future working.

As a result of a suitable selection of the change intervals over the rotation of the rotor, it is thus also possible to influence the position by a targeted variation of the resulting rotor force just by changing the angles of attack γ.

The same applies for a change in the second torque when the angles of attack γ are constant, i.e. when the first torque is constant. This also results in a change in the phase angle Δ and the rotor force which can be varied in a suitable fashion.

There can advantageously also be intermediate solutions between the described cases with the adjustment of just one of the torques and the joint adjustment of both values to influence the rotor force, whilst simultaneously preserving the requirement for synchronicity. In real-life circumstances, in particular for real polychromatic sea states, mixed conditions are more likely to occur, when both values are influenced.

It is thus possible to preserve the required synchronicity, in particular for polychromatic sea states, even in the case of rotors without adjustable angles of attack γ or without an adjustable second torque. A rotor with fixed angles of attack γ can hereby be used, the phase angle Δ and/or effective force of which is the result of adapting just the second torque. An advantage of this system is the reduction of the complexity of the system because active adjustment elements have been removed. The magnitudes of the angles of attack γ are hereby preferably set in opposite directions—one coupling body is pitched inwards, whilst the other coupling body is pitched outwards—at a fixed value of 0° to 20°, preferably 3° to 15°, and particularly preferably 5° to 12°, and most particularly preferably 7° to 10°.

Alternatively, it may also be provided that only one of the coupling bodies has an adjustment device, whilst the other coupling body 3 is mounted at a fixed angle of attack γ.

Alternatively, a rotor can also be used in which the second torque is set to be constant at a mean value, the phase angle Δ and/or rotor force of which is the result of a suitable change in the angles of attack γ, whilst maintaining the required synchronicity.

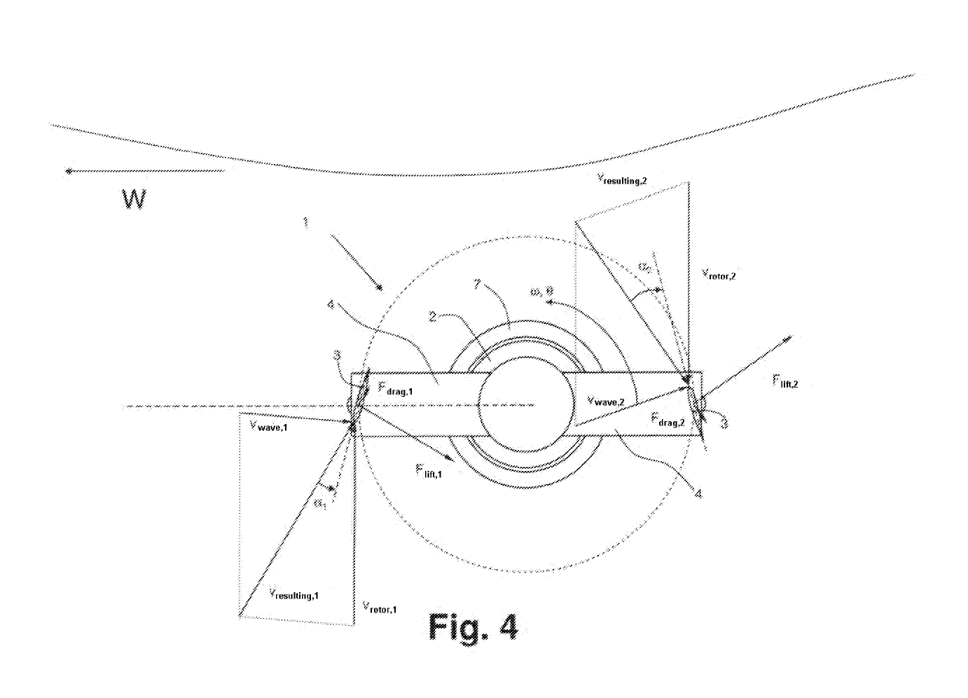

To illustrate the effect of large rotor extents in comparison with wavelength, a wave energy converter 1 has been shown in FIG. 4 in which the diameter is so large that the direction of flow v_{wave} onto the two coupling bodies 3 differs. The rotor here rotates counterclockwise, and the direction in which the waves propagate is from right to left and is labeled W. Below the wave minimum, the water particles thus move largely horizontally from left to right. The left-hand coupling body is arranged slightly before the minimum so that v_{wave,1} is directed slightly downwards and is not yet oriented completely horizontally (same flow as in FIG. 2).

In contrast, the minimum has already passed at the position of the right-hand coupling body so that the flow v_{wave,2} is here directed obliquely upwards. This results in modified flow conditions with a different flow velocity v_{resulting,2} and a different flow angle a₂ than in FIG. 2, in which it was assumed that the direction of flow onto both coupling bodies is identical. The magnitude and direction of action of the two forces F_{lift,2} and F_{drag,2} on this coupling body thus change, as accordingly do the rotor force and rotor torque too.

A similar effect results from the exponential dependence of the velocity of the orbital current on the depth. When the rotor in FIG. 2 is oriented vertically (rotated by 90°), in the case of large rotor extents in comparison with wavelength the flow velocity applied to the lower coupling body 3 is lower than that applied to the upper coupling body 3. This effect also acts correspondingly on the rotor force and rotor torque.

Both effects can, however, be employed or compensated by suitable adaptation of the angle of attack γ—in other words, by adjusting the first torque—and the second torque in order to also ensure synchronicity even under such conditions and/or to influence the rotor force in a suitable fashion.

In the case of large rotor radii with an uneven flow onto the coupling bodies, the phase angle Δ is defined as the angle between the line joining the coupling body 3 facing the orbital current and the center of rotation and the radial direction of flow onto the center of the rotor.

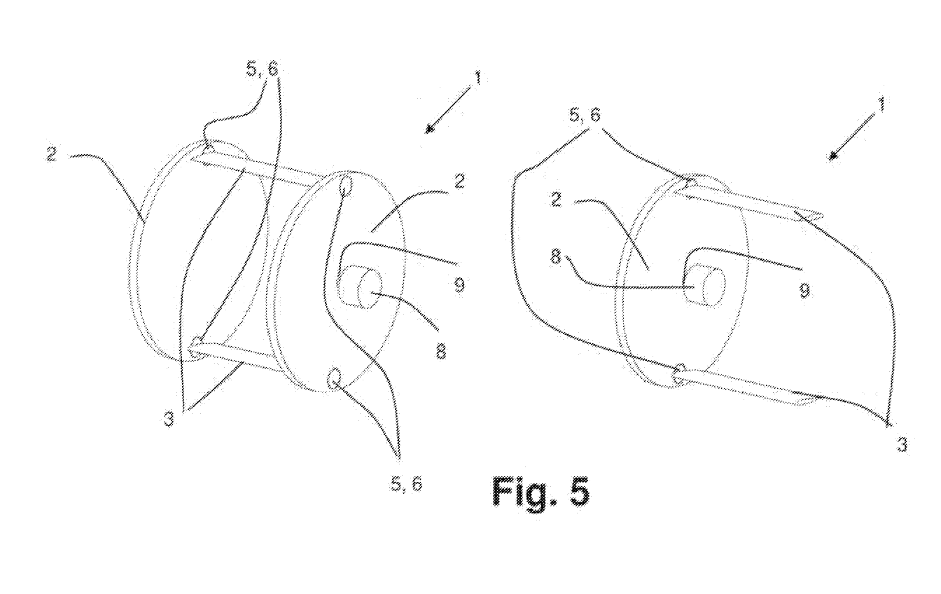

Two embodiments of the wave energy converter 1 are shown in FIG. 5. These each show two coupling bodies 3 which are mounted on one side or on both sides of a rotor base 2. The coupling bodies can be equipped with an adjustment system 5 which serves to actively adjust the angle of attack γ of the coupling body. When the coupling bodies are mounted on both sides, the second side can be rotatably mounted, but it is also possible for an adjustment system 5 to be fitted on both sides. In addition, sensors 6 can be provided for determining the angle of attack γ. A sensor (not shown) for determining the rotational position θ of the rotor base 2 can also be provided.

An energy converter 8, which can for example contain a direct-driven generator, engages on a rotor shaft 9 on the rotor base 2.

Within the scope of this document, rotors in which the coupling body or bodies is or are arranged on just one side of the rotor base 2 are encompassed by the generic term one-sided rotors. Two-sided rotors correspondingly have a two-sided rotor base 2 with respect to its plane of rotation, at least one coupling body being attached to each side of the two-sided rotor base 2.

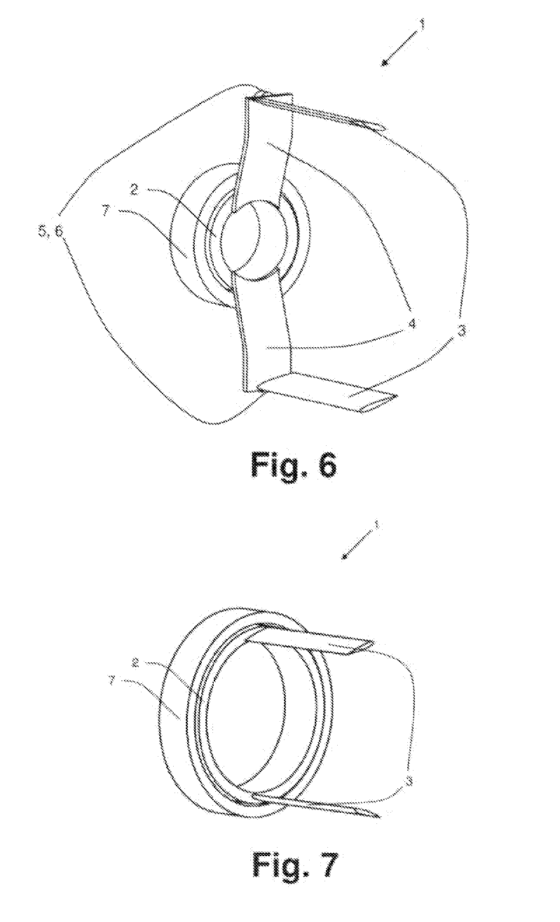

FIG. 6 shows a perspective view of a wave energy converter 1 with a one-sided rotor, in which the coupling bodies 3 are mounted via lever arms 4 on a rotor base 2 mounted in a housing 7. It can thus advantageously be provided that the housing 7 is the stator and the rotor base 2 is the runner of a direct-driven generator. A rotor shaft 9 as in FIG. 6 is no longer included here, which results in savings on structural costs. The length of the lever arms 4 can be designed so that it can be adjusted.

An alternative wave energy converter 1 with a one-sided rotor 2, 3 is shown in FIG. 7 in which the coupling bodies 3 are coupled directly to a rotor base 2 which takes the form of a runner of a direct-driven generator. Adjustment systems for adjusting the coupling bodies 3 and sensors for monitoring the state/determining position are not shown but can, however, be provided. There is also no shaft 9 here.

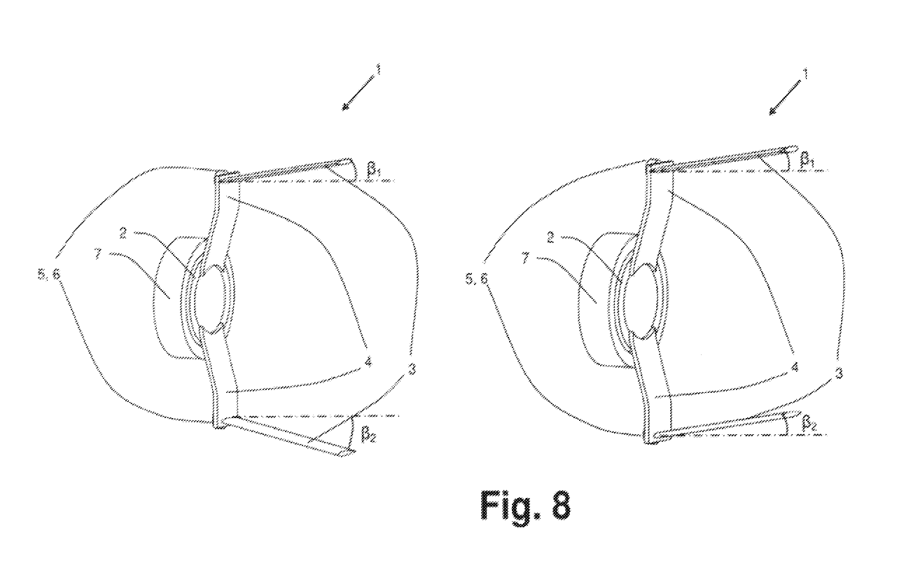

FIG. 8 shows a further wave energy converter 1 with a rotor 2, 3, 4 having coupling bodies 3, in which the coupling bodies 3 are not oriented parallel to the axis of rotation of the rotor 1 but are tilted in a radial direction so that angles β₁ and β₂ exist relative to the rotor axis. The tilt of each coupling body 3 can differ and be independently adjustable and can be superimposed with any existing adjustment of the angle of attack γ.

One advantage of such adjustment of the coupling bodies is that there is a wider range of possible behavior for the machine. A machine with coupling bodies arranged parallel to the axis of rotation is thus optimally designed for a specific wave state with a corresponding wave height and periodic duration and can in ideal circumstances optimally dissipate this wave. In reality, however, very different wave states occur, in particular (multiple) superimposed different wave states.

The rotor 1 according to FIG. 7 thus combines quasi-different machine radii in one machine, so that part of the rotor is always optimally designed for the existing wave state. In particular when combined with the possibility of adjusting this angle, a particularly advantageous rotor thus results with superior properties.

As can be seen on the left in FIG. 8, there is also a possibility of adjusting all the coupling bodies 3 outwards, or as can be seen on the right in FIG. 8, preferably adjusting them in opposite directions, as is also provided for the angles of attack γ. The third possibility in which the coupling bodies are all adjusted inwards has not been shown but can also be advantageous.

By adjusting the coupling bodies so that they are tilted in the radial direction, it is also possible to advantageously influence the direction of the rotor force or effective force. Because the hydrodynamic lift force is oriented perpendicular to the local flow, an axial rotor force component results from adjusting the coupling body in the radial direction, in addition to a rotor force component directed perpendicular to the axis of rotation. This can advantageously be used to stabilize and/or move the rotor.

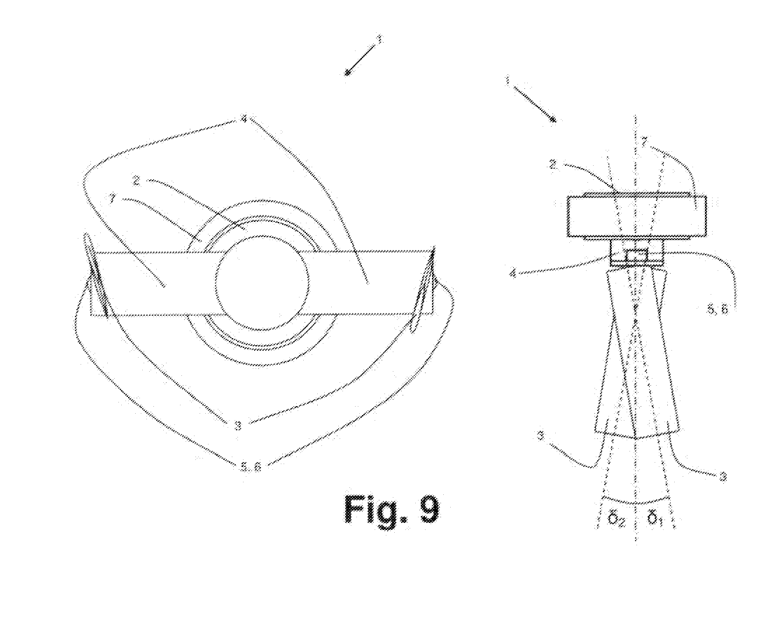

Two views of a further possibility are shown in FIG. 9, in which the coupling bodies 3 do not extend parallel to the axis of rotation. An axial tilting results here, so that angles d₁ and d₂ relative to the rotor axis exist which can be designed such that they can be adjusted via corresponding adjustment devices 5. Such a tilting corresponds to a certain extent to a sweep, as is also used for airplane wings, as a result of which the corresponding advantages known per se can be obtained.

A combination of the differences in the orientation of the coupling bodies from an alignment parallel to the axis of rotation, shown in FIGS. 8 and 9, is also advantageously provided, in particular superimposed with the angle of attack γ of the coupling bodies 3.

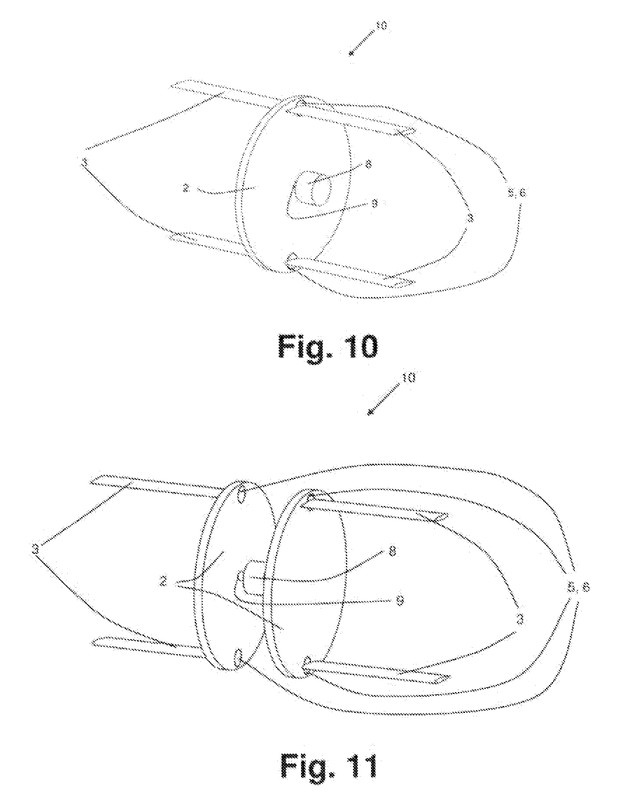

A particularly preferred embodiment of a wave energy converter 10 with a rotor is shown in FIG. 10. This is characterized in that coupling bodies 3 are arranged on both sides of the rotor base 2. As mentioned, such rotors are referred to by the term “two-sided rotor”. The properties and forms mentioned above in the explanations of FIGS. 1 to 9 can be applied and transferred individually or in combination to this wave energy converter with a two-sided rotor. This means that an angle of attack γ of each coupling body 3 and/or the drag and/or the phase angle Δ can be adjustable, that the wave energy converter is configured to operate (largely) with synchronicity, and/or that the resulting rotor force can be varied over the rotation of the rotor by suitably adjusting the angles of attack γ, β and/or d and/or the second torque and/or the phase angle Δ such that a resulting force occurs which can be used for displacing the wave energy converter and/or for compensating superimposed forces, such as for example from currents, and/or for targeted stimulation of vibration and/or stabilization of the wave energy converter.

It can advantageously also be provided that the free ends of the coupling bodies are each mounted in a common base, as is shown for a one-sided rotor in FIG. 5.

If the direction in which a monochromatic wave propagates is directed perpendicular to the axis of rotation of the rotor, this results in the coupling bodies, arranged respectively in pairs next to each other, in ideal circumstances being subject to absolutely identical flow conditions. In this case, the angles of attack γ of these coupling bodies arranged next to each other can preferably be set to be identical. If, in real-life operating circumstances, there is a deviating flow onto the two rotor halves, the angle of attack of each coupling body 3 can be set individually such that the local flow develops optimally.

A rotor torque and a rotor force, which are respectively dependent on the local flow conditions and which can be continually modified by adapting the angles of attack γ, β and/or d and/or the drag, thus result from the superposition of the forces of all the coupling bodies 3. (Partial) synchronicity conditions, explained in connection with FIG. 3, and the generation of the resulting forces can thus also be implemented for such a wave energy converter with a two-sided rotor.

Compared with a wave energy converter 1 with a one-sided rotor according to the previous figures, rotation of the wave energy converter 10 about an axis which is oriented perpendicular to the axis of rotation can also be achieved with a wave energy converter 10 with a two-sided rotor. The wave energy converter 10 can hereby be turned about its vertical axis during operation by differently influencing the angles of attack γ, β and/or d of the coupling bodies 3 and/or by adapting the drag. This can be used particularly advantageously in order to align the wave energy converter 10 such that its rotor axis is oriented largely perpendicular to the currently existing direction in which the waves propagate.

To do this, the strategies explained in connection with FIG. 3 for generating directed resulting forces can be transferred to this wave energy converter 10 with a two-sided rotor in such a way that both sides of the rotor are controlled, for example, in opposite directions. Possible strategies for turning a wave energy converter with a two-sided rotor about the vertical axis can be directly derived by a person skilled in the art.

FIG. 11 shows a further embodiment of a wave energy converter 10 with coupling bodies 3 arranged on both sides. In this embodiment, the rotor base 2 is split into two (part) rotor bases 2 with a rotor shaft 9 arranged in between and an energy converter 8 arranged on the latter and which can, for example, contain a generator and/or a gearbox. Because the two sides of the rotor are connected to each other via the shaft, which may advantageously be largely torsionally stiff, and thus rotate synchronously, this configuration is understood to be a two-sided rotor for which the properties described in connection with FIG. 10 also apply. A structural unit which consists of two one-sided rotors joined together such that the two rotors have largely the same orientation during operation is also understood to be a two-sided rotor.

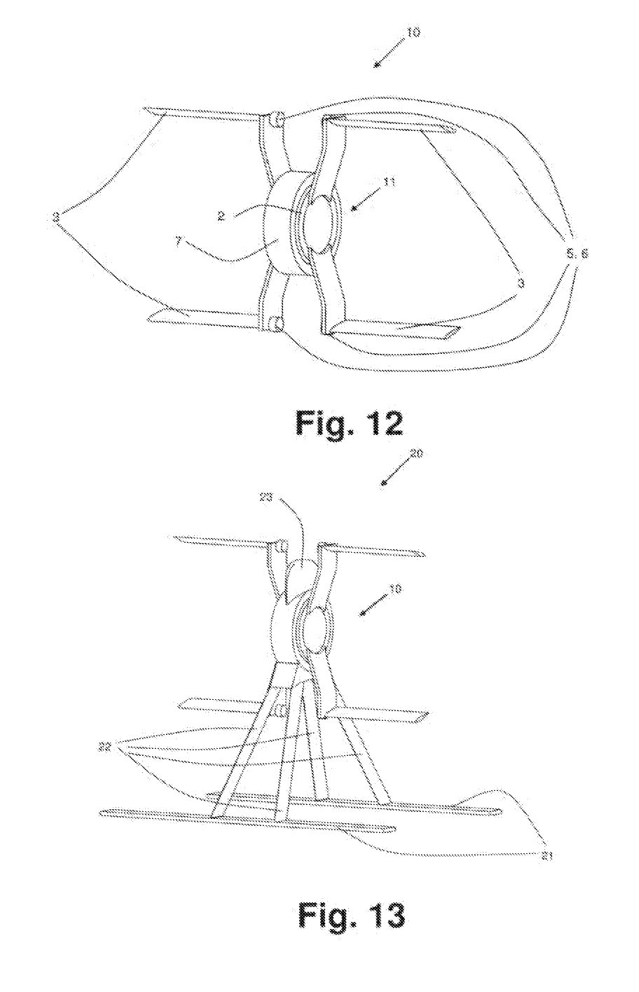

A further embodiment of a wave energy converter 10 with a two-sided rotor 10 is shown in FIG. 12. This is a preferred embodiment in which the energy converter takes the form of a direct-driven generator 11 which, as an integral constituent of the wave energy converter 10 with its stator, forms the non-rotatably mounted housing 7 of the wave energy converter and in which the coupling bodies 3 are coupled directly to the runner 2, acting as the rotor base 2, of the generator 11. This form of wave energy converter 10 thus forms a particularly compact structure in which structural costs are minimized by the omission of a shaft 9. This embodiment can also be combined with the above-described embodiments and operating strategies.

A wave energy converter 20 which comprises further elements in addition to a wave energy converter 10 according to FIG. 12 is shown in FIG. 13. These further elements are, specifically, damping plates 21 which are largely rigidly connected via a frame 22 to the housing 7 or a stator of a direct-driven generator. The damping plates 21 are situated at a greater depth of water than the rotor. At these greater depths of water, the orbital movement of the water molecules caused by the movement of the waves is significantly reduced, so that the damping plates 21 support or stabilize the wave energy converter 20. During operation, a stabilization of the wave energy converter 20 according to the above-described strategies can thus be superimposed with a targeted influencing of the resulting rotor force.

Such a stabilization is advantageous for keeping the axis of rotation stationary in a first approximation. Without such a stabilization, the rotor forces would cause the axis of rotation in an extreme case to orbit with the orbital current with a phase shift, as a result of which the flow conditions of the coupling bodies 3 would change fundamentally. The functionality of the wave energy converter would be negatively influenced as a result. It should, however, be understood that a wave energy converter can also be correspondingly stabilized by other means which do not need to include damping plates.

The two damping plates are shown horizontally, by way of example. Other configurations are, however, also considered to be advantageous, in which the damping plates are oriented differently. For example, the two plates could be arranged so that they are tilted at 45° in opposite directions so that they enclose a 90° angle with each other. Other configurations can be derived by a person skilled in the art. Different geometries or numbers of damping plates can also be used.

It can moreover be provided that the angle and/or damping action of the damping plates 21 can be adjusted. The damping action can, for example, be influenced by changing the fluid permeability. The way in which the wave energy converter 20 responds to the forces introduced can also be influenced by a damping which is changed cyclically in some circumstances.

In addition to the damping plates 21, a hydrostatic buoyancy system 23 can be provided, by means of which the depth to which the wave energy converter is submerged can be set, for example by pumping a fluid in and out. The buoyancy for a stationary case is thus set such that it compensates the weight of the machine and the mooring less the buoyancy that prevails from being immersed in water. Because the rotating parts of the rotor 10 preferably have a largely neutral buoyancy, the weight of the housing, frame, damping plates and a mooring device, explained below, must thus essentially be taken into consideration.

The depth to which the wave energy converter is submerged can be easily regulated by small changes to the buoyancy, in particular in conjunction with a so-called catenary mooring, for example to protect the machine from very heavy seas with too great an energy content by moving it into deeper water, or to bring it to the surface for maintenance.

The machine control system of the wave energy converter 20 can additionally be accommodated in the housing of the buoyancy system 23. One-sided rotors 1 can incidentally also be used as an alternative to a two-sided rotor 10.

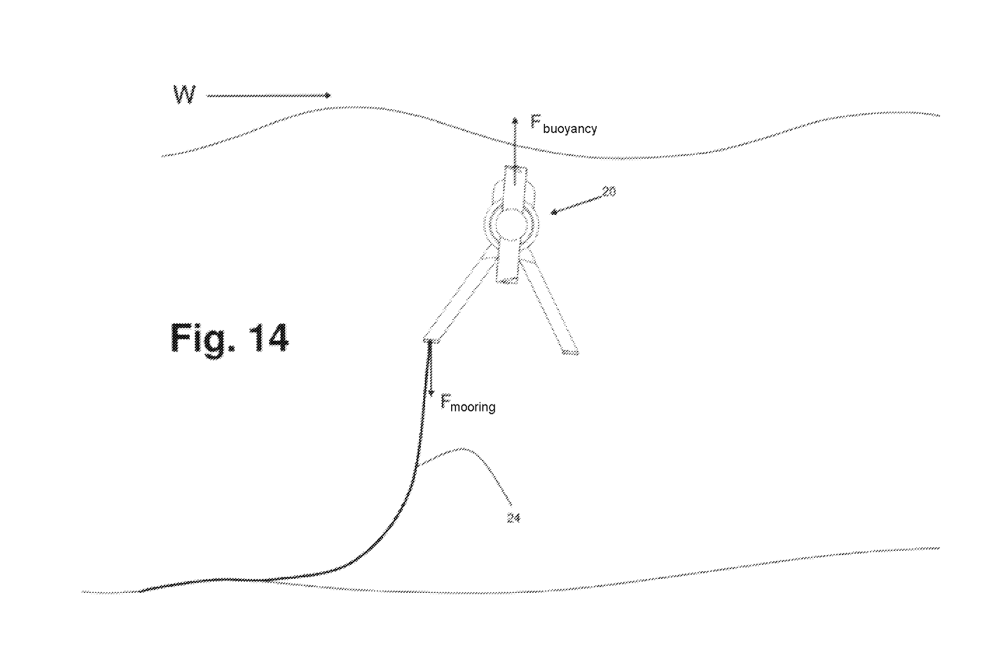

The wave energy converter 20 from FIG. 13 is shown in FIG. 14, in a body of water with a lot of waves with an anchoring 24 to the sea floor which is preferably effected by a mooring, in particular a catenary mooring, but can alternatively also take the form of a rigid anchoring. The direction in which the waves propagate is labeled W. The wave energy converter 20 is connected to the sea floor by one or more chains and corresponding anchors. Corresponding moorings are typically formed from metal chains and can also include at least one synthetic rope, in particular in its upper region.

The wave energy converter end of the mooring is fastened to that part of the frame 22 which faces the arriving wave and/or the damping plate 21 facing the arriving wave. A certain self-alignment of the wave energy converter with the direction in which the wave propagates (weather vane effect) results. This can be assisted by appropriate additional passive systems (weather vane) and/or active systems (rotor control, azimuth tracking).

The combination of buoyancy and anchoring can moreover be used particularly advantageously as support for the generator torque. Also shown are the forces F_{mooring} (largely directed downwards) and F_{buoyancy} (largely directed upwards) caused by these two systems. When a torque is tapped by the drag, in the configuration shown a clockwise rotation of the wave energy converter 20 is induced (in the direction of rotation of the rotor 10). The two forces shown generate a torque directed counter to this rotation, which grows as the tilt of the wave energy converter 20 increases. In addition, tilting of the machine as a result of taking off a generator torque causes the mooring to rise, and consequently F_{mooring} increases. This increases the supporting counter-torque. The buoyancy can additionally also be changed actively in order to increase the counter-torque further to stabilize the wave energy converter.

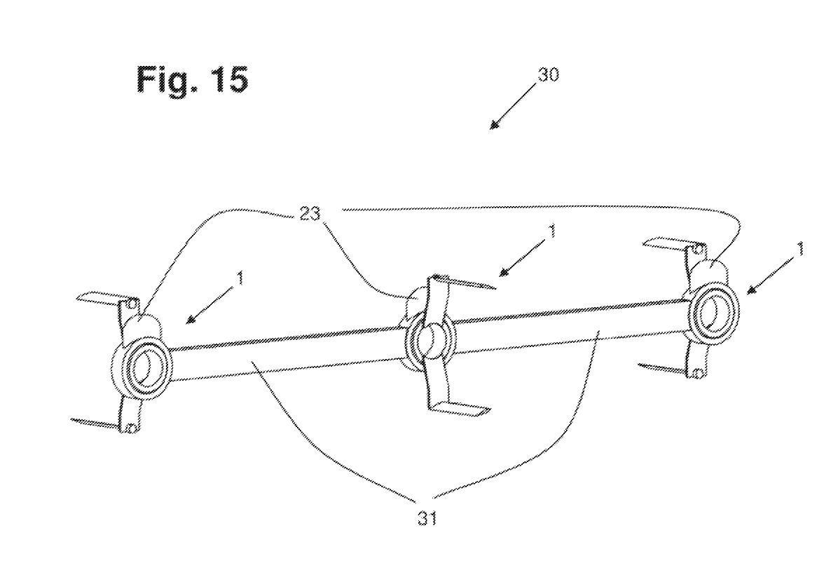

A wave energy converter 30 with three (partial) wave energy converters 1 with one-sided (partial) rotors according to FIG. 6 is shown in FIG. 15. The (partial) wave energy converters are mounted with a largely parallel rotor axis in a horizontally oriented frame 31 so that the rotors are arranged below the surface of the water and their rotor axes are oriented largely perpendicular to the arriving wave. In the case shown, the distance between the first and last rotor corresponds approximately to the wavelength of the sea wave so that, for the assumed case of a monochromatic wave, the frontmost and the rearmost rotor have the same orientation, while the central rotor is turned by 180°. Here all three rotors rotate in a counterclockwise direction, and the shaft thus extends from behind above the machine. The wavelengths of sea waves are between 40 m and 360 m, typical waves having wavelengths of 80 m to 200 m.

Because the flow onto each of the rotors comes from different directions (their position below the wave differs), a specific characteristic results for the direction of the respective rotor force at each rotor. This effect can be used to stabilize the wave energy converter 30 by controlling the individual rotors 1, whilst maintaining a high degree of synchronicity, by adjusting the drag and/or the angles of attack γ, β and/or d, in such a way that the resulting rotor forces of the rotors 1 largely cancel each other out.

Multiple buoyancy systems 23, by means of which the depth to which the wave energy converter is submerged can be regulated and which, together with the anchoring (which is not shown and is preferably attached to that part of the frame 31 which faces the arriving wave and can, for example, take the form of a mooring, in particular a catenary mooring), can generate a counter-torque supporting the damping torque, are advantageously attached to the frame 31 and/or the rotors.

The frame 31 can here be designed in such a way that the distance between the rotors 1 can be set so that the length of the machine can be matched to the existing wavelength. Machines can, however, also be considered which are designed so that they are considerably longer than a wavelength and have a different number of rotors, which means that the stability of the machine can be further improved by superimposing the introduced forces.

Damping plates which can be arranged at greater depths of water can additionally be provided for further stabilization. Buoyancy systems could also be arranged on at least one cross-beam to further stabilize the system, in particular with respect to rotation about the longitudinal axis. Such a cross-beam, preferably oriented horizontally, can, for example, be arranged at the rear end of the frame.

It can also be provided that the frame 31 of the wave energy converter is designed as a floating frame, and that the rotors 1, which are arranged submerged below the surface of the water and have a largely horizontal rotor axis, are rotatably mounted on the floating frame via an appropriately designed frame structure.

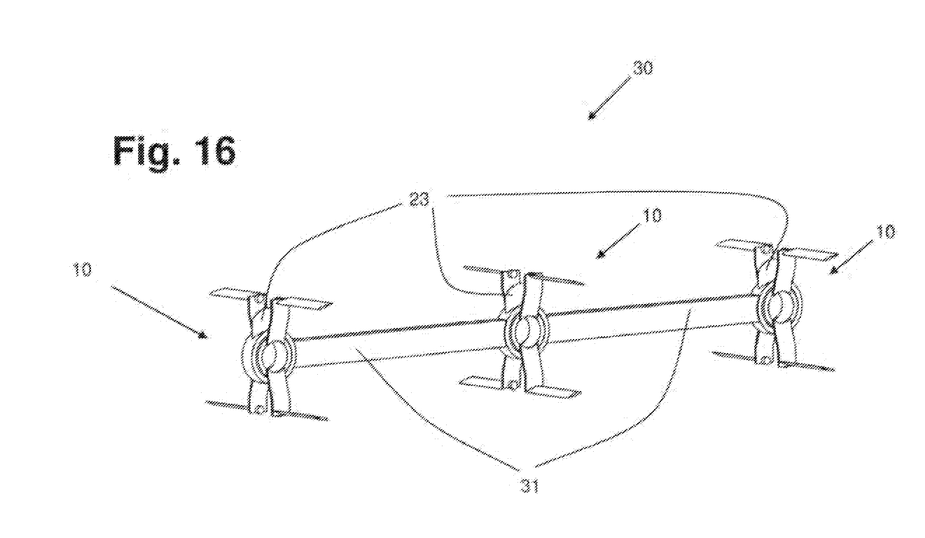

FIG. 16 shows an alternative design of an advantageous wave energy converter 30 with a largely horizontal extension of the frame and a plurality of two-sided rotors. Compared with an arrangement with one-sided rotors, this is a particularly advantageous embodiment as the number of generators is reduced thereby.

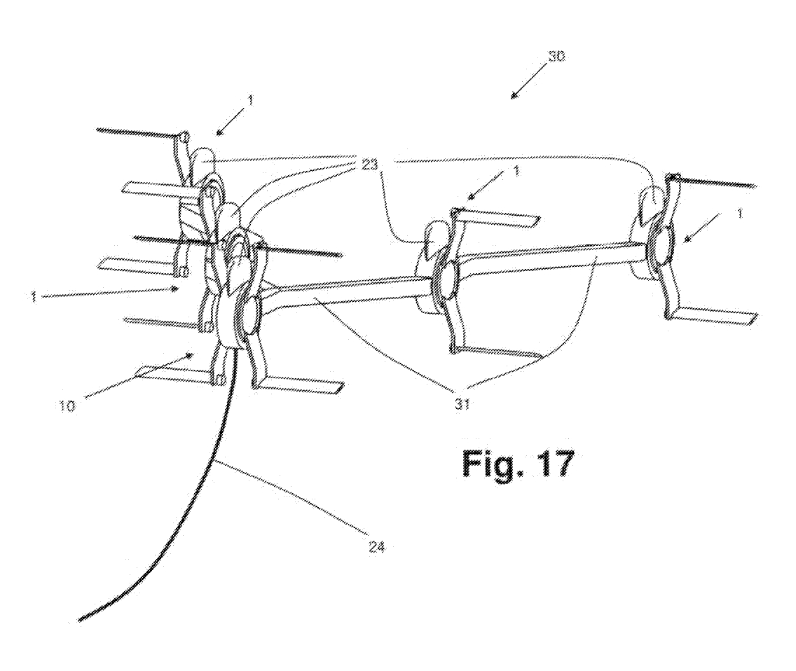

FIG. 17 shows a further alternative design of an advantageous wave energy converter 30 with a combination of a two-sided rotor and a plurality of one-sided rotors and a largely horizontal extension of the frame. The frame 31 is here designed as a V in order to prevent and/or minimize shadowing between the different rotors.

Also shown is an anchoring 24, which is preferably attached to the tip of the V-shaped arrangement so that the wave energy converter 30 aligns itself with respect to the wave by the weather vane effect preferably largely independently in such a way that the wave flows onto it from the front. This results in a largely perpendicular flow onto the rotor axes which can be even further optimized, for example by influencing the rotor forces.

The buoyancy systems which are preferably present can themselves generate a counter-torque but it is also possible to include the anchoring forces of the mooring system 24, as was described in connection with FIG. 14. Stays and/or struts can additionally be provided to stabilize the frame. In addition, stabilization using damping plates in a similar fashion to FIG. 13 can also be provided.

The position and movement behavior of the wave energy converter 30 according to FIGS. 15 to 17 can also be influenced by influencing the rotor forces. Rotation about the vertical axis is also in particular possible here if the different rotors are controlled appropriately.

As well as stabilization using the rotor forces, the wave energy converter 30 is additionally also further stabilized by the current-induced forces which act on the frame 31. These too are directed in different directions and can at least partially cancel each other out.

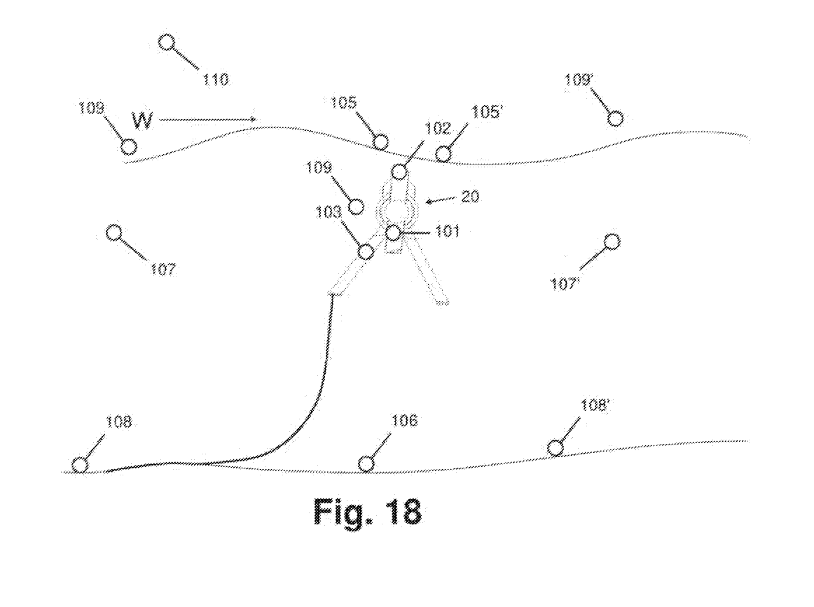

FIG. 18 shows different preferred sensor positions for attaching sensors for determining the current conditions at a wave energy converter 20 and particularly preferably for determining the local flow conditions onto the coupling bodies of a wave energy converter. Moreover, the movement behavior of the wave energy converter 20 can also be determined by sensors attached thereto. The direction in which the waves propagate is labeled W.

Ascertaining the flow conditions onto the coupling bodies, and thus in particular the local velocity and direction of the current, is advantageous for obtaining the required synchronicity and/or for the targeted influencing of the rotor forces. To do this, sensors can be arranged on the rotor (position 101) and/or on the coupling bodies (position 102) and/or on the frame (position 103) and/or floating below the surface of the water close to the machine (position 104) and/or on the surface of the water close to the machine (position 105) and/or on the sea floor below the machine (position 106) and/or floating below the surface of the water upstream from the machine (or an array of several machines) (position 107) and/or on the sea floor upstream from the machine (position 108) and/or floating upstream from the machine (or an array of several machines) (position 109) and/or above the surface of the water (position 110), for example in a satellite. Additional sensors 105′ to 109′ can be arranged downstream with respect to the direction in which the waves propagate. Such downstream sensors make it possible to determine an interaction of the wave energy converter with the waves that have passed through. The result of the interaction can be checked using this knowledge and if necessary the interaction can be changed in a targeted fashion via a machine control system.

Sensors and corresponding combinations from, inter alia, the following categories can be used hereby:
Pressure sensors (for determining differential and/or absolute pressure) for determining hydrostatic and/or hydrodynamic pressures,
Ultrasound sensors for determining current velocities, advantageously in several dimensions,
Laser sensors for determining current velocities and/or the geometry of a water surface,
Acceleration sensors for determining current conditions and/or movements of the overall system and/or the rotor and/or the surface velocities of a body of water and/or for determining the alignment of a body by detecting the Earth's field of gravity,
Inertial sensors for measuring different translational and/or rotational acceleration forces,
Mass flow meters/flow rate sensors and hot wire anemometers for determining a current velocity,
Bending actuators for determining a current velocity,
Strain sensors for determining the deformation of the coupling bodies,
Anemometers for determining a current velocity,
Angle sensors (absolute or incremental), tachometers for determining the angle of attack of the coupling bodies and/or the angle of rotation of the rotor,
Torque sensors for determining the adjusting and/or retaining forces of the coupling body adjustment system,
Power sensors for determining the magnitude and direction of the rotor force,
Satellites for determining the surface geometry of the area of the ocean,
GPS data for determining the position and/or movement of the machine,
Gyroscopes for determining a yaw rate.

The temporary local conditions of the flow onto the coupling bodies and/or the current field around the machine and/or the current field flowing onto the machine/the array of several machines and/or the natural frequency of the machine can be calculated, in particular predictively, from these sensor signals so that the second braking torque and/or the angles of attack γ, β and/or d of the coupling bodies 3 can be suitably set to achieve the control objectives.

As well as optimizing the rotor torque, the control objectives also include maintaining synchronicity and/or preventing the coupling bodies from stalling and/or influencing the rotor forces in order to stabilize and/or displace and/or stimulate the vibration in a targeted fashion and/or turn the system so that it is aligned in the correct position with respect to the arriving wave. Moreover, the depth to which the wave energy converter is submerged and also the supporting torque can be influenced via the control system by changing the at least one buoyancy system. The oscillating behavior of the machine can also be influenced by adapting the damping plate drag.

Measurements of the current field, made upstream from the machine or an array of several machines, are thus established particularly advantageously and the current field occurring at the machine or machines at a later point in time can be calculated from them. Using a virtual model of the machine, pilot control of the variables can be derived therefrom which is then adapted by a control system. Using such a procedure, it is in particular possible to mathematically ascertain the essential energy-bearing wave components in polychromatic sea states, and modulate the control system of the energy converter in a suitable fashion with respect to these components.

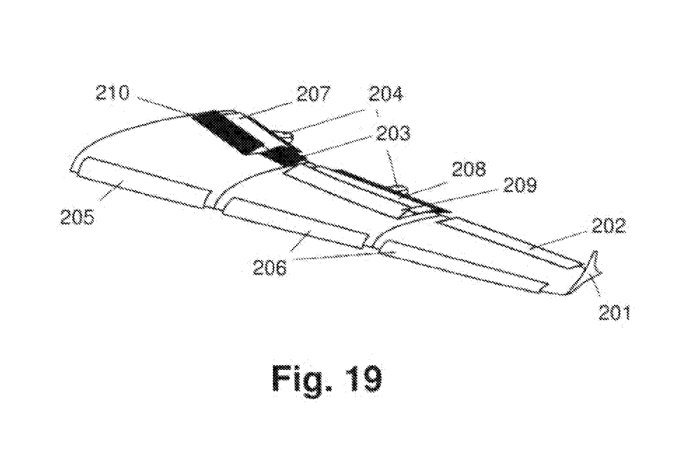

Alternative possibilities, known from airplane manufacturing, in particular flaps, for changing the angle of attack γ of a lift runner and/or its shape are shown in FIG. 19 and labeled 201 to 210, by means of which the flow over the runner and hence the lift and/or drag forces can be influenced. It may be provided that the coupling bodies 3 are equipped with one or more of these means in addition to or as an alternative to an actuator for adjusting the angle of attack γ, β and/or d.

The use of so-called winglets for influencing the lift behavior at the free ends of the wing is here considered in particular. It is alternatively possible to provide the free ends of the wing with a second rotor base and thus to increase the mechanical stability of the overall system too.

For the sake of simplicity, symmetrical profiles have been used in the drawings. It should be pointed out here that curved profiles can also be used. Moreover, the curvature of the profiles used can be adapted to the current conditions (curved current).

What is claimed is:

1. A method for operating a wave energy converter for converting energy from a wave movement of a fluid into a different form of energy, with at least one rotor and at least one energy converter coupled to the at least one rotor, comprising:
generating a first torque acting on the at least one rotor by the movement of the waves;
generating a second torque acting on the at least one rotor by the at least one energy converter; and
setting a desired effective force acting perpendicular to an axis of rotation of the at least one rotor by setting the first torque and/or the second torque.

2. The method according to claim 1, wherein:
the movement of the waves is an orbital current, and
a rotational movement of the at least one rotor about the rotor axis is largely or completely synchronized with the orbital current by a targeted setting of the first torque and/or the second torque.

3. The method according to claim 2, wherein a phase angle between the orbital current and the rotational movement of the at least one rotor is set or controlled at a value or within a range of values.

4. The method according to claim 1, wherein:
at least one coupling body connected to the at least one rotor is used in order to generate the first torque from the movement of the waves by generating a hydrodynamic lift force, and
the magnitude and/or direction of the hydrodynamic lift force is set by changing the position and/or form of the at least one coupling body.

5. The method according to claim 1, wherein a braking or accelerating torque is applied to the at least one rotor at least temporarily by the at least one energy converter as a second torque.

6. The method according to claim 1, wherein:
the first torque and/or the second torque is changed cyclically, according to a frequency of the movement of the waves and/or a rotational movement of the at least one rotor respectively, and
the effective force is a force resulting over time from a reaction force acting on a retaining structure of the at least one rotor.

7. The method according to claim 6, wherein the first torque is increased or reduced largely synchronously with the second torque within one or more angular position intervals of a rotational movement of the at least one rotor.

8. The method according to claim 1, wherein a position of the wave energy converter in the fluid is changed in the lateral and/or vertical direction by the effective force generated, and/or the wave energy converter is aligned and/or turned laterally and/or vertically in the fluid and/or a force acting on the wave energy converter, due to largely continuous fluid currents, is counteracted, and/or the wave energy converter is stabilized and/or a movement state of the wave energy converter is changed in a targeted fashion.

9. The method according to claim 1, wherein local, regional and/or global flow conditions of the fluid with respect to the wave energy converter and/or its components and/or alignment of the wave energy converter and/or a movement state of the wave energy converter and/or a phase angle between an orbital current and a rotational movement of the at least one rotor, over time, are detected as operating conditions and used to set the first and/or second torque.

10. The method according to claim 9, wherein:
polychromatic fluctuations in the operating conditions are detected, and
main modes in the polychromatic fluctuations are used to set the first and/or second torque.

11. The method according to claim 10, wherein multiple rotors are used and an identical or different effective force is generated respectively.

12. A wave energy converter for converting energy from the wave movement of a fluid into a different form of energy, comprising:
at least one rotor;
at least one energy converter coupled to the at least one rotor; and
a control device,
wherein the at least one rotor is configured so as to generate a first torque acting on the at least one rotor from the movement of the waves,
wherein the at least one energy converter is configured so as to generate a second torque acting on the at least one rotor, and
wherein the control device is configured so as to set the first torque and/or the second torque by corresponding activation of the wave energy converter such that a desired effective force acting perpendicular to an axis of rotation of the at least one rotor is set.

13. The wave energy converter according to claim 12, wherein the control device is configured to control the at least one rotor and the at least one energy converter so as to convert energy from the wave movement of a fluid into a different form of energy.

14. The wave energy converter according to claim 12, wherein:
the at least one rotor has at least one coupling body configured to generate the first torque from the movement of the waves by generating a hydrodynamic lift force, and
the control device is configured so as to set a magnitude and/or a direction of the hydrodynamic lift force by changing a position and/or shape of the at least one coupling body.

15. The wave energy converter according to claim 14, wherein the at least one coupling body is attached to at least one rotor base at a distance from the axis of rotation of the at least one rotor.

16. The wave energy converter according to claim 12, wherein:
the at least one rotor has a two-sided rotor base with respect to its plane of rotation and in each case at least one coupling body on each side of the rotor base.

17. The wave energy converter according to claim 16, wherein means are provided for independently or jointly adjusting the coupling bodies.

18. The wave energy converter according to claim 12, wherein the at least one rotor has at least two rotor bases and at least one coupling body attached between two rotor bases in each case.

19. The wave energy converter according to claim 12, wherein:
the at least one energy converter is designed as a direct-driven generator, and
the at least one rotor is the drive for the generator.

20. The wave energy converter according to claim 19, wherein the rotor of the direct-driven generator forms the rotor base of the at least one rotor.

21. The wave energy converter according to claim 12, further comprising:
at least one stabilizing frame and/or damping plates configured to stabilizing the wave energy converter;
an anchoring means for anchoring the wave energy converter; and/or
a torque support means for receiving a torque.

22. The wave energy converter according to claim 12, further comprising:
a plurality of one-sided rotors and/or two-sided rotors attached to an elongated V-shaped structure.

23. The wave energy converter according to claim 12, further comprising:
a means for changing a hydrostatic lift force which are configured so as to set a submerged depth of the wave energy converter and/or for tilting it in the fluid and/or for applying a torque to the wave energy converter.

24. The wave energy converter according to claim 12, further comprising:
at least one sensor and/or at least one sensor system configured to determine a position of the rotor and/or coupling body and/or a phase angle between an orbital current and a rotational movement of the at least one rotor and/or an operating state of the wave energy converter and/or a wave state, a wave height, a wavelength, a wave frequency, a direction in which the waves propagate and/or a velocity at which the waves propagate and/or a current field and/or a flow direction,
wherein the at least one sensor and/or the at least one sensor system has sensors arranged on the wave energy converter, in its vicinity and/or remote from it.
